(19) United States
(12) Patent Application Publication
(10) Pub. No.: US 2024/0330724 A1
(43) Pub. Date: Oct. 3, 2024

(54) PROVIDING MONITORED DEVICE PARAMETERS TO A KNOWLEDGE BASE SYSTEM FOR USE IN SERVICE ACTION DETERMINATION

(71) Applicant: Lenovo Enterprise Solutions (Singapore) Pte Ltd., Singapore (SG)

(72) Inventors: Fred Allison Bower, III, Durham, NC (US); Jarrod B. Johnson, Raleigh, NC (US); Shyam Sareen, Cary, NC (US)

(73) Assignee: Lenovo Global Technology (United States) Inc., Morrisville, NC (US)

(21) Appl. No.: 18/194,014

(22) Filed: Mar. 31, 2023

(51) Int. Cl. G06N 5/04; G06N 5/022

(52) U.S. Cl. CPC G06N 5/04; G06N 5/022

(57) ABSTRACT

A system management node may perform various operations including receiving a particular event code from a monitored device, wherein the particular event code represents an event that occurred on the monitored device. The operations may further include sending a knowledge base query to a server hosting a knowledge base, wherein the knowledge base query includes the particular event code, and sending a value of a device parameter specific to the monitored device to the server hosting the knowledge base, wherein the value of the device parameter specific to the monitored device enables the knowledge base to refine a determination of a service action to be included in a response. Still further, the operations may include receiving the response from the server hosting the knowledge base, wherein the response identifies a service action to implement on the monitored device to remediate the event that occurred on the monitored device.

### BACKGROUND

The present disclosure relates to the use of a knowledge base system to identify service actions suggested for dealing with an event that has occurred at a monitored device.

### BACKGROUND OF THE RELATED ART

Monitored devices in a datacenter, such as a compute node or data storage device, may collect data regarding errors and events, analyze the errors and events, and then present data regarding those errors or events to a user for problem determination and diagnosis. However, before those errors or events may be remediated, the user may need to access a knowledge base containing information about many different errors or events and associated service actions that are recommended for remediating with those errors and events. Unfortunately, an error or event code that is output from the monitored device as a result of the event may lead to a generic service action that is not appropriate or optimal to the specific circumstances.

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations may comprise receiving a particular event code from a monitored device, wherein the particular event code represents an event that occurred on the monitored device. The operations may further comprise sending a knowledge base query to a server hosting a knowledge base, wherein the knowledge base query includes the particular event code, and sending a value of a monitored device parameter to the server hosting the knowledge base, wherein the value of the monitored device parameter enables the knowledge base to refine a determination of a service action to be included in a response. Still further, the operations may comprise receiving the response from the server hosting the knowledge base, wherein the response identifies a service action to implement on the monitored device to remediate the event that occurred on the monitored device.

Some embodiments provide a method comprising receiving a particular event code from a monitored device, wherein the particular event code represents an event that occurred on the monitored device. The operations may further comprise sending a knowledge base query to a server hosting a knowledge base, wherein the knowledge base query includes the particular event code, and sending a value of a monitored device parameter to the server hosting the knowledge base, wherein the value of the monitored device parameter enables the knowledge base to refine a determination of a service action to be included in a response. Still further, the operations may comprise receiving the response from the server hosting the knowledge base, wherein the response identifies a service action to implement on the monitored device to remediate the event that occurred on the monitored device.

### BRIEF DESCRIPTION OF THE SEVERAL VIEWS OF THE DRAWINGS

FIG. 1 is a diagram of a system for use of a knowledge base to identify services actions.

FIG. 2 is an illustration of a metadata file.

FIG. 3 is an illustration of a knowledge base.

FIG. 4 is an illustration of a user interface displaying a log viewer.

FIG. 5 is a flowchart of operations between a monitored device and a system management node to send monitored device configuration data, log data related to an event, and implement a service action.

FIG. 6 is a flowchart of operations between a system management node and a web server hosting the knowledge base system, where a metadata file is accessible to the system management node.

FIG. 7 is a flowchart of operations between a system management node and a web server hosting the knowledge base system, where a metadata file is accessible to the web server hosting the knowledge base system.

### DETAILED DESCRIPTION

Some embodiments provide a computer program product comprising a non-volatile computer readable medium and non-transitory program instructions embodied therein, the program instructions being configured to be executable by a processor to cause the processor to perform various operations. The operations may comprise receiving a particular event code from a monitored device, wherein the particular event code represents an event that occurred on the monitored device. The operations may further comprise sending a knowledge base query to a server hosting a knowledge base, wherein the knowledge base query includes the particular event code, and sending a value of a monitored device parameter to the server hosting the knowledge base, wherein the value of the monitored device parameter enables the knowledge base to refine a determination of a service action to be included in a response. Still further, the operations may comprise receiving the response from the server hosting the knowledge base, wherein the response identifies a service action to implement on the monitored device to remediate the event that occurred on the monitored device.

In some embodiments, the processor that performs the various operations may be a component of a system management node, such as a remote computer hosting a system management interface or a dedicated system management console. The system management node may include the processor, which includes a processor unit with multiple processors and/or processor cores, and may host the computer program product. The system management node may be, without limitation, a laptop, desktop or tower computer, a dedicated management server or a virtual machine hosted by a server in a virtualization environment. In one example, the system management node may host system management software, such as Lenovo XClarity Administrator. One module of the system management software may be a log parser.

The monitored device may be any type of compute node that is being monitored and/or managed by the system management node. For example, the monitored device may be a datacenter server, a computer on a local area network (LAN) or wide area network (WAN), or an edge computer. Furthermore, the monitored device may be any other type of equipment that creates alerts in response to events requiring service attention and having log data that is used in conjunction with the problem determination and remediation process. Non-limiting examples of such monitored devices include storage devices, network routers and switches, tape libraries, and power distribution units. The monitored device may be one of many monitored devices that are under management by the same system management node, such that the system management node may monitor and/or manage many or all of the monitored devices in according with some embodiments. Still further, the configuration of each monitored device may vary, including different device types, different device hardware models, different device hardware expansion modules, different operating systems and versions, and the like. Accordingly, the monitored device may differ from other monitored devices in the same network or under management by the same system management node.

The particular event code represents an event that occurs on the monitored device. Event codes may follow an event code standard or may be proprietary event codes for a particular systems integrator or manufacturer. The event codes may represent events of any severity (i.e., critical events, warning events and/or informational events) and from any source (i.e., hardware events, management events, serviceable events, customer serviceable events, and/or non-serviceable events). The event code may be included in an event notification and may be accompanied by other data, such as a date and time of the event, the identity of the monitored device where the event occurred and the serviceability of the event code. Each event code may have a numerical or alphanumerical value associated with a predefined event description that a user may read to get a better understanding of the event. As a non-limiting example of an event code, event ID 10016 in Microsoft Windows is used to encode an event for application permissions not being granted for a particular activity that is attempting to perform an action requiring those permissions. This example of an event has a warning-level of severity. Embodiments may use a knowledge base system to receive a recommended service action that may be taken to resolve or remediate the problem that led to the event represented by the event code.

The knowledge base is a collection of information that is useful to provide a recommended service action in response to an event occurring on one of the monitored devices. The knowledge base may include a record or entry for a plurality of event codes that may be generated by the monitored device. For each of the event codes included in the knowledge base, there may be one or more service actions or one or more sets of service actions identified. For example, the knowledge base may recommend a first service action (or first set of service actions) to remediate a particular event identified by a particular event code generated by a monitored device having a first configuration, whereas the knowledge base may recommend a second service action (or second set of service actions) to remediate the same event identified by the same event code generated by a monitored device having a second configuration. The difference between the first and second monitored device configurations may be described by the values of one or more monitored device parameters. In such instances, the knowledge base may use the values of one or more monitored device parameters to determine which service action or set of service actions to recommend. Embodiments provide a metadate file that identifies, for each event code, what one or more monitored device parameter may be useful to selecting the most effective service action(s) for the monitored device that generated the event code (i.e., the monitored device that experienced the event).

The monitored devices, system management node and web server hosting the knowledge base may be in communication over a local area network and/or a wide area network. Using the networks, the system management node may obtain monitored device configuration and/or vital product data, event notifications and logs from each monitored device in a system. The networks may also be used to support communication between the system management node and the web server, such as the system management node sending the knowledge base query to the knowledge base system hosted by the web server and receiving a response from the knowledge base system. The knowledge base query preferably includes the particular event code for which the system management node requests more information, such as a recommended service action. Other communications of the various embodiments may be similarly supported by the network(s).

The configuration of each monitored device may be described by one or more monitored device parameter, such as a monitored device hardware make, model, type and/or version; installed hardware component types, versions, and/or capacity; operating system identity, version, plugins and/or settings; applications, drivers, firmware version and other aspects of the monitored device configuration. A monitored device parameter may be one or more qualitative or categorical variable, one or more quantitative variable, or one or more combinations thereof. Accordingly, the values of the monitored device parameters may be numeric (quantitative values), non-numeric (qualitative or identifying values), or some combination thereof (such as a manufacturer/model/type identifier combined with a version/style/capacity number).

Embodiments include the system management node sending a value of a monitored device parameter to the server hosting the knowledge base, wherein the value of the monitored device parameter enables the knowledge base to refine a determination of one or more service actions to be included in a response. The system management node may receive the response from the server hosting the knowledge base, wherein the response identifies the one or more service actions to implement on the monitored device to remediate the event that occurred on the monitored device. The service actions may include, without limitation, checking operating conditions, checking for proper installation, checking environmental conditions, changing setting, rebooting, restoring an original configuration, replacing a component, updating firmware or software, install additional storage or memory, and/or purchase a license.

In some embodiments, the system management node and/or the knowledge base system will access a metadata file including a plurality of records, each record including an event code and a monitored device parameter associated with the event code. The metadata file is used to identify the monitored device parameter that is associated with the particular event code and may be helpful to refine the query result or response to includes a more specific or more accurate recommendation of one or more service action. For example, the metadata file may include a record for each event code that the knowledge base associates with more than one or more service actions or sets of service actions depending upon, or uniquely associated with, the value of the monitored device parameter.

In some embodiments, the metadata file may be automatically generated by identifying, for each event code in the knowledge base, the monitored device parameter that is used to advance along a decision tree of the knowledge base to reach a service action that is more specific to the monitored device where the event occurred. Accordingly, updates to the knowledge base may be automatically reflected in an update to the metadata file so that the monitored device parameter(s) may be used to identify one or more recommended service actions.

In some embodiments, the metadata file may be a manually created list of additional data that an expert would require when analyzing of an issue identified by a log output from a monitored device. For example, the identified issue may be represented by an error or event code. Optionally, the metadata file may be prepared by a system development entity, such as the same entity or organization that creates the knowledge base and/or the log parser. However, creation of the metadata file, which includes entries identifying types of additional information (monitored device parameters) helpful in selecting a specific service action for a given error or event code, could be automated by collecting data about software and hardware dependencies and/or data reflecting how issues are debugged and diagnosed during field service calls.

Embodiments include methods to automatically provide additional information (in addition to the error or event code) during a knowledge base query from the user's log viewer. This additional information may be used to obtain a more specific set of instructions from the knowledge based than could be obtained using a single error code lookup. The user's log viewer may, without limitation, run on a remote system management console.

Embodiments of the log parsing process may access a metadata file to identify additional information (a monitored device parameter) that is needed to improve the fidelity or accuracy of results from a knowledge base lookup or query. For example, if a knowledge base query with a general error code would cause the knowledge base to generate a plurality of different service recommendations (recommended service actions) depending upon other considerations, such as the specific operating system installed on the monitored device and/or the model of the monitored device, then the metadata file may specify that the operating system version and/or the monitored device model should be included in the knowledge base lookup or query. The log parser may, for each error or event notification, create a hyperlink (or simply “link”) with a specific Uniform Resource Locator (URL) that corresponds to the error code lookup in the knowledge base with an appended token of the additional information. Thus, when the user clicks the link to view results of the knowledge base query, the knowledge base will receive the query and the token in order to provide a recommended service action that is specific to the monitored device model and operating system for the monitored device that generated the error or event notification. The additional information about the monitored device within the token provided with the query improves the ability of the knowledge base to provide accurate service recommendations without requiring multiple manual data inputs from the user. Because the specific data that may be useful to enable the knowledge base to identify the most accurate service recommendations for any given error or event notification may change over time, the metadata file may be updated periodically to modify the additional inputs (monitored device parameters) that should be provided along with an error or event code in the lookup or query to the knowledge base.

In some embodiments the metadata file may be stored with the system management node for direct access by the log parser, but in other embodiments the meta data file may be stored with the web server hosting the knowledge base system. If the metadata file is stored with the knowledge base system, the system management node may send the knowledge base query and then receive a request for the value of the monitored device parameter from the server hosting the knowledge base. The system management node may then respond to the request by sending the value of the monitored device parameter. Where the metadata file is stored on the server hosting the knowledge base system, a knowledge base response to a query may optionally include a query result page with a link that, in response to user selection of the link, will pull the value of the monitored device parameter from the log parser and provide the value to the knowledge base enabling the knowledge base to identify a more accurate recommended service action that is specific to the event code in the query and the value of the monitored device parameter. For example, with the knowledge base aware of the format of log parser output, the knowledge base can create a hyperlink that includes a query string pointing to the parameters needed for additional analysis fidelity improvement. Locating the metadata file in a centralized location, such as the same server as the knowledge base, may be preferred if the metadata file is very large or is frequently modified. Optionally, the metadata file may be stored on, or copied to, the system management node and updated when updates become available.

In some embodiments, the log parser may present the link received from the knowledge base system in a user interface where the link is logically associated with the error or event notification, such that the user may click (select or activate) the link to receive information about a recommended service action for the dealing with the error or event.

Some embodiments of the system management node may host a programmatic analysis tool that interacts with the knowledge base in real time to provide the knowledge base system with any required information, such as one or more monitored device parameter. In such a system, it may be preferable to have the metadata file stored on the same server as the knowledge base system, since the programmatic analysis tool can perform additional data retrieval for the knowledge base. The programmatic analysis tool may be a software module running on a system management node and may be either an extension to the log parser or a replacement of the log parser.

In some embodiments, the system management node may display the event code in a user interface, such as a log parser user interface, and may further displaying a hyperlink to the knowledge base in the user interface adjacent to the event code. The hyperlink may be configured so that the knowledge base query is sent to the server hosting the knowledge base in response to user selection of the hyperlink. In one option, the system management node may receive and store a plurality of links to the knowledge base, wherein each of the links is associated with one of the event codes and links to one or more service action associated with the event code. The hyperlink displayed in the user interface adjacent to the event code may be obtained from the stored plurality of links.

In some embodiments, the system management node may receive an event notification from the monitored device, wherein the event notification includes the event code. The system management node may then display the event notification on a user interface. Log data from the monitored device may be requested in response to user input to investigate and/or remediate the event identified by the event notification. A user may identify a need to collect and analyze the log of a monitored device in response to receiving an event notification at a management node or in response to observing abnormal operational behavior of the monitored device. Logs are typically maintained local to each monitored device. For example, a baseboard management controller within a compute node may collect and maintain a log and/or an operating system running on the compute node may collect and maintain a log. The one or more logs may include some duplication, but the BMC log may have more data related to hardware events and the operating system log may have more data related to software and application events.

Improved analysis of an event can be performed if all of the log data is transferred to the knowledge base, but the transfer of the log data is often impractical and presents a concern for privacy and security. Information from the knowledge base can also be periodically sent to a system management node that runs a log parsing program (i.e., a “log parser”) such that the log parser may store and maintain links into the knowledge base. However, it may be cumbersome for the system management node to maintain a full and current copy of the knowledge base and such systems can lead to situations where different instances or versions of the knowledge base may yield different answers to the same log data input. Such inconsistency can erode confidence that the knowledge base will recommend the most appropriate action.

The log data that is parsed may have a deterministic filesystem structure that allows the computer hosting the knowledge base system (“backend” system) to embed file:///style links into the html output from the knowledge base that will dynamically pull data from the specific parsed data set to populate dynamic fields in the analysis result. While the log parser may create or enter an HTML link pointing to the knowledge base, the knowledge base may dynamically build a customized HTML page containing links to the data contained in the log file that is accessible to the log parser. Accordingly, the data may be pulled from the log file without the log parser having any prior knowledge of what additional data is needed for the query. This allows the log parser to include the additional monitored device data (monitored device parameters and/or log data specified by the metadata file) into its analysis via the presentation of a link to the user that, in response to being clicked or selected, provides both the query (error or event code) and the additional monitored device data (monitored device parameters) to the knowledge base. The knowledge base may update the references or links to the data that is needed to provide the most relevant information/recommendation to the user without having to distribute the references or links to become part of the log parser. Rather, the references or links are kept in the centralized location along with the knowledge base.

Performance of a recommended service action (remediation) is typically decoupled from analysis of the log since the log parsing function is being performed on the system management node, which may not have access to the monitored device from which the logs were extracted. However, the actual implementation of the recommended service action involves taking action with regard to the monitored device whether that action is taken remotely or locally. To the extent that the monitored device is accessible to the system management node and the remediation (recommended service action) is something that can be done without physical reconfiguration (i.e., parts replacement or other physical manipulation of the equipment), the system management node may automatically cause the identified service action to be implemented on the monitored device. Alternative to, or in combination with, an automatic service action, the system management node may prompt a user to physically implement an identified service action on the monitored device.

Some embodiments provide a method comprising receiving a particular event code from a monitored device, wherein the particular event code represents an event that occurred on the monitored device. The operations may further comprise sending a knowledge base query to a server hosting a knowledge base, wherein the knowledge base query includes the particular event code, and sending a value of a monitored device parameter to the server hosting the knowledge base, wherein the value of the monitored device parameter enables the knowledge base to refine a determination of a service action to be included in a response. Still further, the operations may comprise receiving the response from the server hosting the knowledge base, wherein the response identifies a service action to implement on the monitored device to remediate the event that occurred on the monitored device.

Some embodiments provide a computer program product comprising a non-volatile computer readable medium and non-transitory program instructions embodied therein, the program instructions being configured to be executable by a processor to cause the processor to perform various operations. The operations may comprise receiving a knowledge base query from a system management node, wherein the knowledge base query includes a particular event code that represents an event that occurred on a component monitored by the system management node. The operations may further comprise accessing a metadata file including a plurality of records, each record including an event code, a monitored device parameter associated with the event code, and a recommended service action, and identifying, using the metadata file, the monitored device parameter that is associated with the particular event code. Still further, the operations may comprise sending a request to the system management node for a value of the identified monitored device parameter for the monitored device, receiving the value of the identified monitored device parameter for the monitored device from the system management node, and identifying, using the knowledge base, a recommended service action associated with the particular event code and the received value of the identified monitored device parameter for the monitored device. The operations may also comprise sending a response to the system management node, wherein the response identifies a recommended service action to remediate the event that occurred on the monitored device.

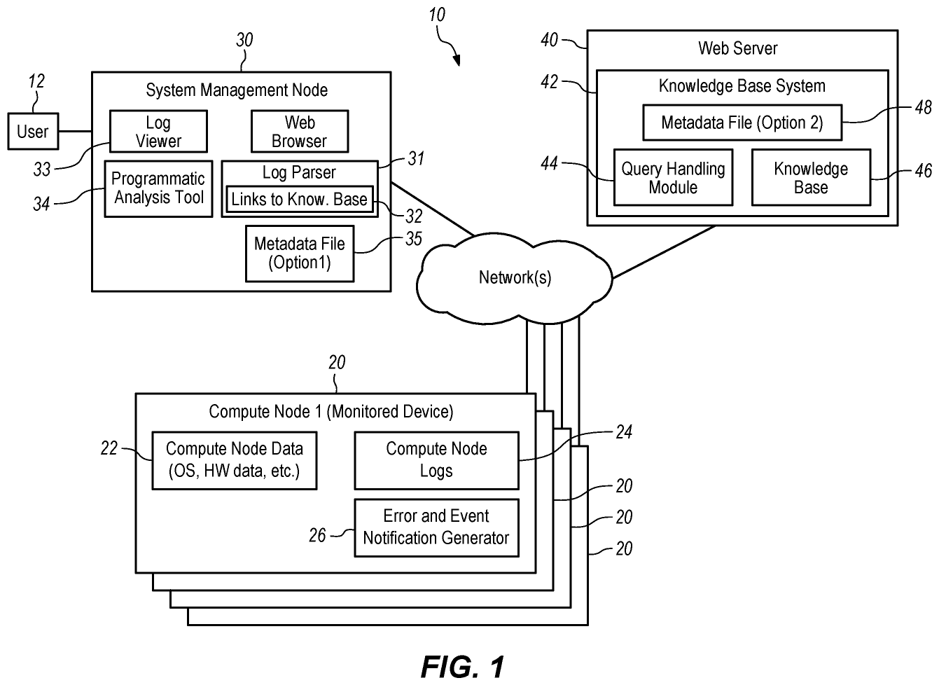

FIG. 1 is a diagram of a system 10 for use of a knowledge base to identify services actions. The system 10 includes a plurality of compute nodes 20 (representative of a monitored device) under management by a system management node 30. The system management node 30 may host a log parser 32 or similar application that communicates with each compute node 20 to receive compute node data 22 including the values of various compute node parameters, such as configuration data or vital product data. During operation of each compute node 20, the compute node 20 may collect compute node logs 24 that can be shared with the system management node 30. Each compute node 20 may also include an error and event notification generator 26 that identifies the occurrence of an event on the compute node 20 and forwards an event notification to the system management node 30. While the system management node 30 may communicate with each compute node 20, the information from an individual compute node 20 is uniquely identified with the compute node and used to troubleshoot events occurring on the individual compute node.

The system management node 30 includes an application program 31, such as a log parser application, that performs or controls many of the functions of various embodiments herein. The log parser 31 may, depending upon the embodiment implemented, include links 32 to a knowledge base, include or interface with a log viewer 33, include or interface with a programmatic analysis tool 34, access and use a metadata file 35, and/or use a web browser to support communication with the compute node 20, a web server, and/or a user 12. After receiving an event code from one of the compute nodes 20, the log parser 31 may send a knowledge base query to the knowledge base system 42 hosted by a web server 40.

The knowledge base system 42 may include a query handling module 44, a knowledge base 46, and a metadate file 48. The query handling module 44 may handle communications with the system management node 30, such as receiving the knowledge base query and/or any subsequent values of compute node parameters and sending the knowledge base response and/or requests for the values of additional compute node parameters. The knowledge base 46 stores the service actions that are recommended for each of a plurality of event codes. Furthermore, the knowledge base may include different recommended service actions depending upon not only the particular event code but also depending upon the value one or more compute node parameter of the particular compute node where the event occurred. The metadate file 48 identifies for each event code, what compute node parameter(s) is useful to identifying a recommended service action that is most specific to the compute node. While FIG. 1 illustrates a metadata file 35 on the system management node 30 and a metadata file 48 as part of the knowledge base system 42, it is not necessary for any of the embodiments to have the metadata file in both locations, although having the metadata file in both locations is not prohibited.

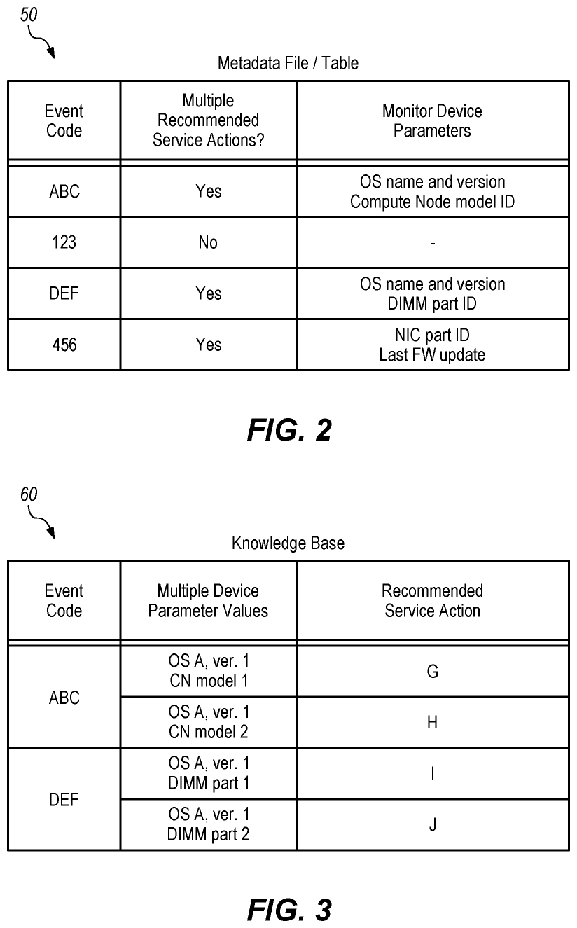

FIG. 2 is an illustration of a metadata file or table 50 that includes a plurality of records, where each record is illustrated as a row. The metadata file 50 may be representative of either of the metadata files 35, 48 in FIG. 1. Each record (row) associates an event code (first column) with monitored device parameters (third column) that should be provided in association with a knowledge base query that includes the event code. The metadata file can be used to improve the accuracy of the recommended service action output to the user from the knowledge base. A second column shows whether there are multiple service actions dependent upon a value of a monitored device parameter, but this column is provided primarily for illustration. Note that for the event code “123” there is only a single recommended service action regardless of the value of monitored device parameters, such that the metadata file is not identifying any monitored device parameters that should be provided in association with the event code.

FIG. 3 is an illustration of a knowledge base 60 that may be representative of the knowledge base 46 in FIG. 1. The knowledge base 60 includes a plurality of records (rows). In this non-limiting illustration, each of the two records identify an error code associated with multiple recommended service actions, where each recommended service action is associated with unique values of certain monitored device parameter (such as an operating system version and/or a monitored device model identifier).

Specifically, a first record is provided for the event code “ABC”. However, the recommended service action (third column) may be either “G” or “H” depending upon the values of certain monitored device parameters. For a first event code “ABC” (first row), if the monitored device has an operating system A of version 1 (“OS A, ver. 1”) and a monitored device model number 1 (“CN model 1”) then the recommended service action is “G”, whereas if the monitored device has an operating system A of version 1 (“OS A, ver. 1”) and a monitored device model number 2 (“CN model 2”) then the recommended service action is “H”. For a second event code “DEF” (second row), if the monitored device has an operating system A of version 1 (“OS A, ver. 1”) and a dual in-line memory module (DIMM) part number 1 (“DIMM part 1”) then the recommended service action is “I”, whereas if the monitored device has an operating system A of version 1 (“OS A, ver. 1”) and a DIMM part number 2 (“DIMM part 2”) then the recommended service action is “J”.

Note that the monitored device parameter values (column 2) of the knowledge base 60 in FIG. 3 are the values that correspond to the monitored device parameters (column 3) of the metadata file 50 in FIG. 2. The metadata file 50 indicates that for an event code “ABC”, the knowledge base query should include the values of a first monitored devices parameter “OS name and version” and a second monitored device parameter “Compute node model ID”. Once the knowledge base receives the event code “ABC” and the specific values of the monitored device parameters for the monitored device (i.e., “OS A, ver. 1” and “CN model 1”) experiencing the event, then the knowledge base may identify the record using the event code, then further refine the recommended service action by using the values of the monitored device parameters.

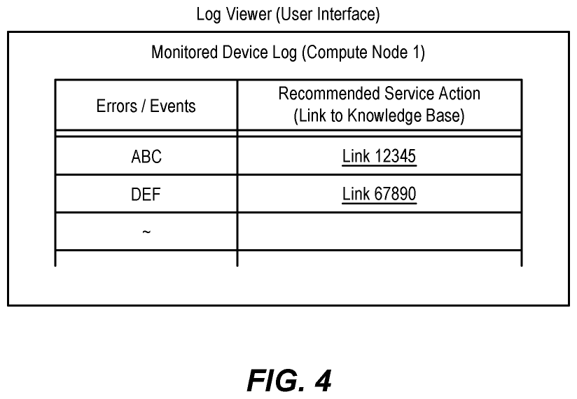

FIG. 4 is an illustration of a user interface 70 displayed to a user by the log viewer. While other information is likely to also be shown, a monitored device log or series of events are displayed for a user to view. For each event (first column), the log viewer provides a link (second column) to the knowledge base where there is a recommended service action associated with the event. If the user clicks (selects or activates) one of the links, the system management node will send a knowledge base query including the event code to the knowledge base system. In some embodiments, the system management node may simultaneously provide values of the monitored device parameters necessary to facilitate the refinement of the knowledge base response.

The user interface displays a monitored device log that identifies one or more error or event records for the monitored device (“Compute Node 1”) and, for each event record a clickable/selectable link to a service action recommended by the knowledge base in view of the event code and the values of the monitored device parameters for Compute Node 1.

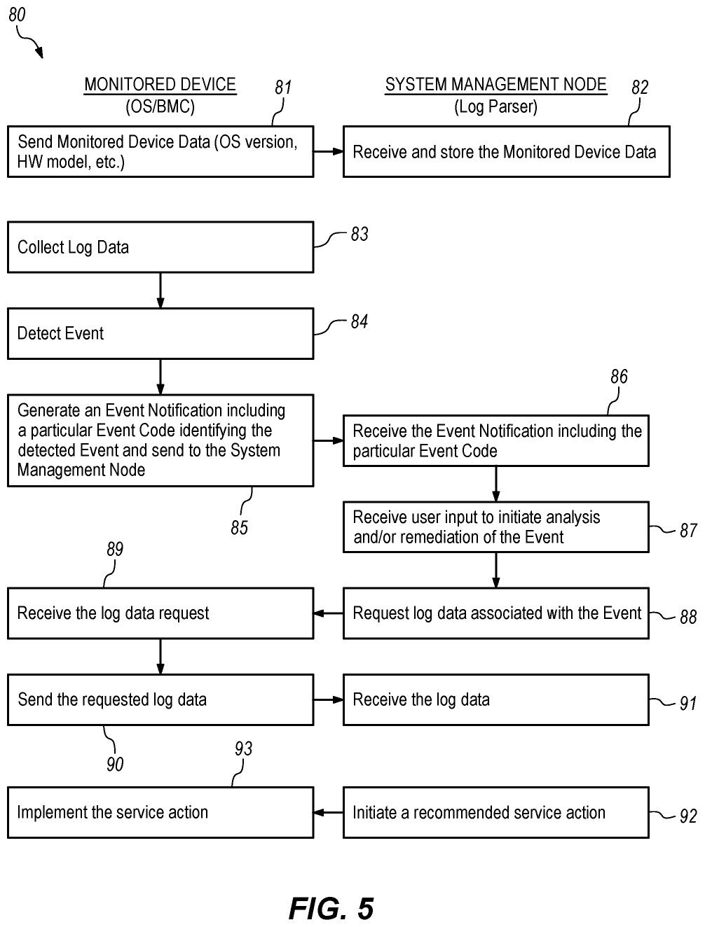

FIG. 5 is a flowchart of operations 80 between a monitored device and a system management node to send monitored device configuration data, log data related to an event, and implement a service action. In operation 81, the monitored device sends monitored device data, such as an operating system version, hardware model and other information, to the system management node. In operation 82, the system management node receives and stores the monitored device data. These operations may occur as part of an initial system setup and kept up to date. Alternatively, these operations may occur on an ad hoc basis as the system management node requires additional monitored device data.

In operation 83, the monitored device collects log data and, in operation 84, the monitored device detects an event within the monitored device. In operation 85, the monitored device generates an event notification including a particular event code identifying the detected event and sends the event notification to the system management node. In operation 86, the system management node receives the event notification including the particular event code. In operation 87, the system management node receives user input to initiate analysis and/or remediation of the event. In operation 88, the system management node requests log data associated with the event. In operation 89, the monitored device receives the log data request and, in operation 90, the monitored device sends the requested log data. In operation 91, the system management node receives the log data.

In operation 92, the system management node may optionally initiate a recommended service action, either automatically or in response to user input instructing the initiation of the recommended service action. In operation 93, the monitored device implements the service action.

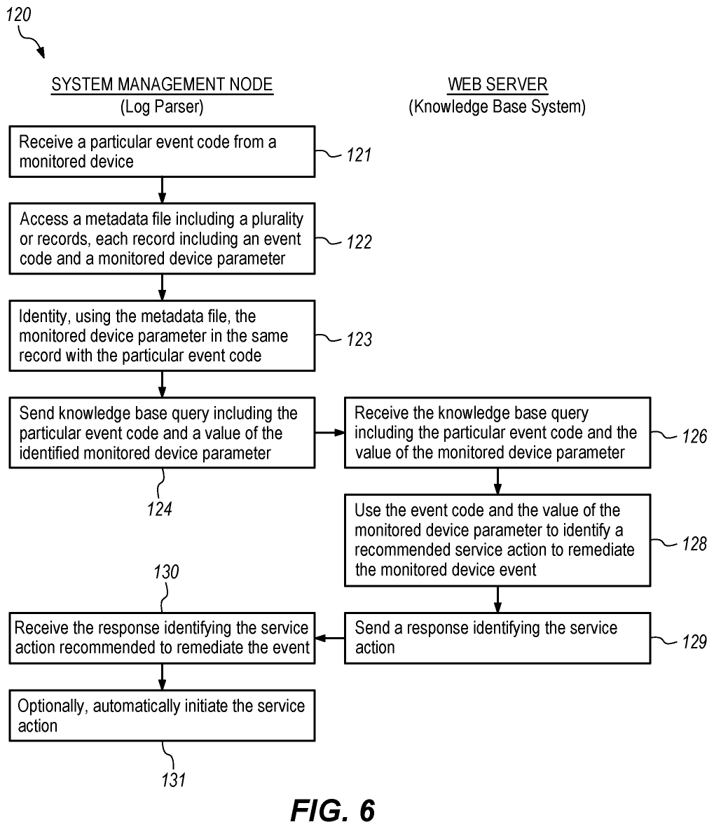

FIG. 6 is a flowchart of operations 120 between a system management node and a web server hosting the knowledge base system, where a metadata file is accessible to, or stored by, the system management node. In operation 121, the system management node receives a particular event code from a monitored device. In operation 122, the system management node accesses a metadata file including a plurality of records, each record including an event code and a monitored device parameter. In operation 123, the system management node identifies, using the metadata file, the monitored device parameter in the same record with the particular event code.

In operation 124, the system management node sends a knowledge base query to the knowledge base system, the knowledge base query including the particular event code and a value of the identified monitored device parameter. In operation 126, the knowledge base system receives the knowledge base query including the particular event code and the value of the monitored device parameter.

In operation 128, the knowledge base system uses the event code and the value of the monitored device parameter to identify a recommended service action to remediate the monitored device event. In operation 129, the knowledge base system sends a response identifying the service action. In operation 130, the system management node receives the response identifying the service action recommended to remediate the event. In operation 131, the system management node may optionally automatically initiate the service action.

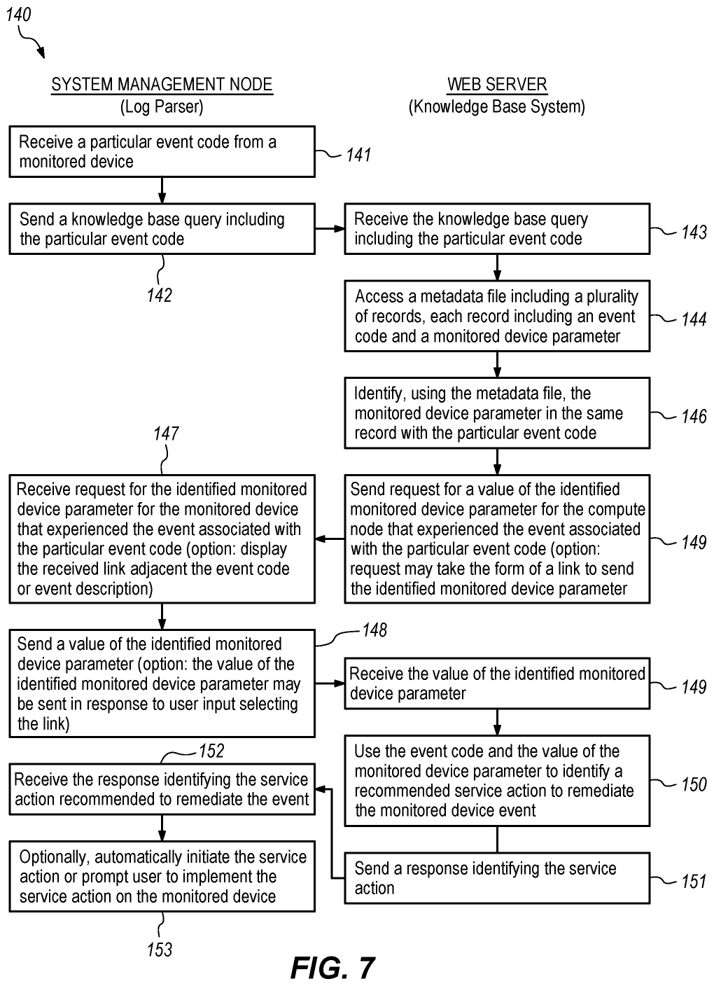

FIG. 7 is a flowchart of operations 140 between a system management node and a web server hosting the knowledge base system, where a metadata file is accessible to, or stored by, the web server hosting the knowledge base system. In operation 141, the system management node receives a particular event code from a monitored device. In operation 142, the system management node sends a knowledge base query including the particular event code.

In operation 143, the knowledge base system receives the knowledge base query including the particular event code. In operation 144, the knowledge base system accesses a metadata file including a plurality of records, each record including an event code and a monitored device parameter. In operation 145, the knowledge base system identifies, using the metadata file, the monitored device parameter in the same record with the particular event code. In operation 146, the knowledge base system sends a request for a value of the identified monitored device parameter for the monitored device that experienced the event associated with the particular event code. In one option, the request may take the form of a link to send the identified monitored device parameter.

In operation 147, the system management node receives the request for the identified monitored device parameter for the monitored device that experienced the event associated with the particular event code. In the foregoing option where the request is a link, the system management node may display the received link adjacent the event code or event description. In operation 148, the system management node sends a value of the identified monitored device parameter to the knowledge base system. With the optional feature, the value of the identified monitored device parameter may be sent in response to user input selecting the link.

In operation 149, the knowledge base system receives the value of the monitored device parameter. In operation 150, the knowledge base system uses the event code and the value of the monitored device parameter to identify a recommended service action to remediate the monitored device event. In operation 151, the knowledge base system sends a response identifying the service action and, in operation 152, the system management node receives the response identifying the service action recommended to remediate the event. In operation 153, the system management node optionally automatically initiates the service action or prompts the user to implement the service action on the monitored device.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon. Furthermore, the operations of the computer program product embodiments may be also be implemented as the operations of a method.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
receiving a particular event code from a monitored device, wherein the particular event code represents an event that occurred on the monitored device;
accessing a metadata file including a plurality of records, each record including an event code and a device parameter associated with the event code;
identifying, using the metadata file, the device parameter that is associated with the particular event code;
sending a knowledge base query to a server hosting a knowledge base, wherein the knowledge base query includes the particular event code received form the monitored device and a value of the device parameter that is specific to the monitored device, wherein the value of the device parameter for the monitored device enables the knowledge base to refine a determination of a service action to be included in a response; and
receiving the response from the server hosting the knowledge base, wherein the response identifies a service action to implement on the monitored device to remediate the event that occurred on the monitored device.

2. The computer program product of claim 1, wherein the metadata file includes a record for each event code that the knowledge base associates with more than one service action depending upon the value of device parameter.

3. The computer program product of claim 1, wherein the value for the device parameter that is specific to the monitored device is automatically sent to the server in the knowledge base query.

4. The computer program product of claim 1, the operations further comprising:
receiving an update to the metadata file from the server.

5. The computer program product of claim 1, wherein the device parameter is an operating system version installed on the monitored device, a firmware version installed on the monitored device, and/or a model number of the monitored device.

6. The computer program product of claim 5, wherein the knowledge base uses the value of the device parameter that is specific to the monitored device and the particular event code to identify the service action.

7. The computer program product of claim 1, the operations further comprising:
displaying the event code in a user interface;
displaying a hyperlink to the knowledge base in the user interface adjacent to the event code, wherein the knowledge base query is sent to the server hosting the knowledge base in response to user selection of the hyperlink.

8. The computer program product of claim 7, the operations further comprising:
receiving user input selecting the hyperlink to the knowledge base, wherein the knowledge base query is sent to the server in response to receiving the user input selecting the hyperlink.

9. The computer program product of claim 7, the operations further comprising:
receiving and storing a plurality of links to the knowledge base, wherein each of the links is associated with one of the event codes and links to one or more service action associated with the event code, where the hyperlink displayed in the user interface adjacent to the event code is obtained from the stored plurality of links.

10. The computer program product of claim 1, the operations further comprising:
receiving an event notification from the monitored device, wherein the event notification includes the event code;
displaying the event notification on a user interface; and
requesting the log data from the monitored device in response to user input requesting to investigate and/or remediate the event identified by the event notification.

11. The computer program product of claim 1, wherein the value of the device parameter associated with the particular event code is provided in a token, and wherein the token is sent to the knowledge base.

12. The computer program product of claim 1, the operations further comprising:
automatically causing the identified service action to be implemented on the monitored device.

13. The computer program product of claim 1, the operations further comprising:
prompting a user to physically implement the identified service action on the monitored device.

14. A computer program product comprising a non-volatile computer readable medium and non-transitory program instructions embodied therein, the program instructions being configured to be executable by a processor to cause the processor to perform operations comprising:
receiving a knowledge base query from a system management node, wherein the knowledge base query includes a particular event code that represents an event that occurred on a device monitored by the system management node;
accessing a metadata file including a plurality of records, each record including an event code, a device parameter associated with the event code, and a recommended service action;
identifying, using the metadata file, the device parameter that is associated with the particular event code;
sending a request to the system management node for a value of the identified device parameter that is specific to the monitored device;
receiving the value of the identified device parameter that is specific to the monitored device from the system management node;
identifying, using the knowledge base, a recommended service action associated with the particular event code and the received value of the identified device parameter; and
sending a response to the system management node, wherein the response identifies a recommended service action to remediate the event that occurred on the monitored device.

15. The computer program product of claim 14, wherein the metadata file is stored on the server hosting the knowledge base.

16. The computer program product of claim 14, wherein the request sent to the system management node includes a query result page with a link that, in response to user selection of the link, will cause the system management node to send the value of the device parameter that is specific to the monitored device in a response to the request.

17. The computer program product of claim 14, wherein the metadata file is automatically generated by identifying, for each event code in the knowledge base, the device parameter that is used to advance along a decision tree of the knowledge base to reach a service action that is more specific to the monitored device where the event occurred.

18. The computer program product of claim 17, wherein the knowledge base includes a plurality of records, wherein each record identifies an event code and one or more service actions associated with the event code, and wherein at least one of the records of the knowledge base identifies multiple service actions associated with the event code, wherein each of the multiple service actions is uniquely associated with a different value of the device parameter.

19. The computer program product of claim 14, wherein the log data from the monitored device has a deterministic filesystem structure, wherein the server hosting the knowledge base embeds a link into HTML output in the response from the knowledge base, and wherein the embedded link will pull data from the log data set to populate a dynamic field in the response.

20. The computer program product of claim 14, wherein the device parameter is an operating system version installed on the monitored device, a firmware version installed on the monitored device, a model number of the monitored device, and/or a model number of the monitored device.
